(19) United States
(12) Patent Application Publication
(10) Pub. No.: US 2026/0097550 A1
(43) Pub. Date: Apr. 9, 2026

(54) METHOD FOR PELLETIZING SINGLE USE PLASTIC AND POST CONSUMER RECYCLE MATERIALS

(71) Applicant: US Refinity, Inc., Corpus Christi, TX (US)

(72) Inventors: Rand S. Blair, Corpus Christi, TX (US); J.Scott Sheppard, Colleyville, TX (US); Randall D. Teel, Anahuac, TX (US); Nathan A. Harris, Republic, MO (US)

(73) Assignee: US Refinity, Inc., Corpus Christi, TX (US)

(21) Appl. No.: 19/352,907

(22) Filed: Oct. 8, 2025

Related U.S. Application Data
(60) Provisional application No. 63/704,864, filed on Oct. 8, 2024.

(51) Int. Cl. B29C 48/00; B29B 17/02; B29B 17/04; B29C 48/36

(52) U.S. Cl. CPC B29C 48/0022; B29B 17/0206; B29B 17/0412; B29C 48/022; B29C 48/36; B29B 2017/0272

(57) ABSTRACT

A method comprising: resizing Post Consumer Recycle (PCR) material and Post Commercial/Post Industrial material to 270 mesh particles; mixing the resized material into a homogeneous blend, wherein the blend comprises at least 10% Post Consumer Recycle (PCR) material and at least 10% Post Commercial/Post Industrial material; heating the homogeneous blend to a temperature greater than 110° F.; extruding the homogeneous blend through an orifice between 2.0 mm and 10.0 mm in diameter to form a rope; and cutting the rope into pellets at least 5.0 mm in length. A pellet comprising: at least 10% Post Consumer Recycle (PCR) material and at least 10% Post Commercial/Post Industrial material; and having a diameter between 2.0 mm and 15.0 mm and a length of between 2.0 mm and 25.0 mm.

### CROSS-REFERENCE TO RELATED APPLICATIONS

This application claims priority to U.S. Provisional Patent Application No. 63/704,864, filed on Oct. 8, 2024 with the U.S. and Trademark Office. The entire contents of which are incorporated herein by reference for all purposes.

### TECHNICAL FIELD

The present disclosure relates to recycling plastic material.

### BACKGROUND

Millions of tons of plastic pollution is being pumped into the world every year. Plastic material ends up everywhere. It is now found in the deepest oceans, on the highest peak, and is even appearing inside of people's bodies.

The accepted grouping of waste plastics for potential recycling are Post Consumer Recycle (PCR), Post Commercial, and Post Industrial. Accepted groups of potential recycle materials are made up of the “one through seven” most common types of plastic:
(1) Polyethylene Terephthalate (PET);
(2) High Density (HDPE);
(3) Polyvinyl Chloride (PVC or Vinyl);
(4) Low Density (LDPE);
(5) Polypropylene (PP);
(6) Polystyrene (PS or Styrofoam); and
(7) Other, plastic cannot be identified.
   Post Consumer Recycle (PCR) material largely comprises: Polyethylene Terephthalate (PET) (group 1); Polyvinyl Chloride (PVC or Vinyl) (group 3); Polystyrene (PS or Styrofoam) (group 6); and other unidentified plastic (group 7). Post Commercial and Post Industrial material largely comprises: High Density Polyethylene (HDPE), Polyethylene (PE), and Polyphenylene Ether (PPE) (group 2); Polypropylene (PP) (group 4); and Polystyrene (PS or Styrofoam) (group 5).

The most difficult to recycle of the waste materials are Post Consumer purchased streams, deemed disposable and reclaimed from residences and communities, consisting of packaging, container, wrap, film, labels, bottles, caps, plates, cups, and utensils, without limitation. Post Consumer purchased streams are largely rejected after single use. Logistical and economic factors determine which of these types of plastic are recycled, for example, the most widely recycled plastics are HDPE and PET, that make products like soft drink bottles, milk and water bottles.

There is a need to recycle more of the different groups of waste plastics.

### SUMMARY OF THE INVENTION

Aspects provide a method comprising: resizing Post Consumer Recycle (PCR) material to 270 mesh particles; resizing Post Commercial/Post Industrial material to 270 mesh particles; mixing the resized Post Consumer Recycle (PCR) material and the resized Post Commercial/Post Industrial material into a homogeneous blend, wherein the blend comprises at least 10% Post Consumer Recycle (PCR) material and at least 10% Post Commercial/Post Industrial material; heating the homogeneous blend to a temperature greater than 110° F.; extruding the homogeneous blend through an orifice between 2.0 mm and 15.0 mm in diameter to form a rope; and cutting the rope into pellets between 2.0 mm and 25.0 mm in length.

An aspect of a method of the previous paragraph comprising: resizing Post Consumer Recycle (PCR) material to 325 mesh particles; and resizing Post Commercial/Post Industrial material to 325 mesh particles.

An aspect of a method of one of the previous two paragraphs comprising: resizing Post Consumer Recycle (PCR) material to 400 mesh particles; and resizing Post Commercial/Post Industrial material to 400 mesh particles.

An aspect of a method of one of the previous three paragraphs wherein the homogeneous blend comprises at least 20% Post Consumer Recycle (PCR) material and at least 20% Post Commercial/Post Industrial material.

An aspect of a method of one of the previous four paragraphs wherein the homogeneous blend comprises at least 30% Post Consumer Recycle (PCR) material and at least 30% Post Commercial/Post Industrial material.

An aspect of a method of one of the previous five paragraphs wherein the homogeneous blend comprises at least 40% Post Consumer Recycle (PCR) material and at least 40% Post Commercial/Post Industrial material.

An aspect of a method of one of the previous six paragraphs wherein the homogeneous blend comprises at least 50% Post Consumer Recycle (PCR) material and at least 50% Post Commercial/Post Industrial material.

An aspect of a method of one of the previous seven paragraphs comprising heating the homogeneous blend to a temperature greater than 130° F.

An aspect of a method of one of the previous eight paragraphs comprising heating the homogeneous blend to a temperature greater than 150° F.

An aspect of a method of one of the previous nine paragraphs comprising extruding the homogeneous blend through an orifice between 4.0 mm and 6.0 mm in diameter to form a rope.

An aspect of a method of one of the previous ten paragraphs comprising cutting the rope into pellets at least 10.0 mm in length.

According to aspects, there is provided a pellet comprising: at least 10% Post Consumer Recycle (PCR) material and at least 10% Post Commercial/Post Industrial material; and having a diameter between 2.0 mm and 15.0 mm and a length between 2.0 mm and 25.0 mm.

An aspect of a pellet of the previous paragraph comprising: at least 20% Post Consumer Recycle (PCR) material and at least 20% Post Commercial/Post Industrial material.

An aspect of a pellet of one of the previous two paragraphs comprising: at least 30% Post Consumer Recycle (PCR) material and at least 30% Post Commercial/Post Industrial material.

An aspect of a pellet of one of the previous three paragraphs comprising: at least 40% Post Consumer Recycle (PCR) material and at least 40% Post Commercial/Post Industrial material.

An aspect of a pellet of one of the previous four paragraphs comprising: at least 50% Post Consumer Recycle (PCR) material and at least 50% Post Commercial/Post Industrial material.

### BRIEF DESCRIPTION OF THE DRAWINGS

The figures illustrate example pellets made from single-use plastics and Post Consumer hard to recycle materials and PE and/or PPE film, label and wrap (also difficult to recycle) for use in various currently available manufacturing equipment and processes to make end products from the recycled material. Processes form making pellets are also illustrated.

FIG. 1 shows a block diagram of a recycled plastic pellet forming system.

FIG. 2 shows a flow chart of a process that homogeneously blends single-use plastics and Post Consumer hard to recycle materials with PE and/or PPE film, label and wrap (also difficult to recycle) into pellets suitable for use in various currently available manufacturing equipment and processes to make end products from the recycled material.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided a process that homogeneously blends 50% of single-use plastics and Post Consumer hard to recycle materials with 50% PE and/or PPE film, label and wrap (also difficult to recycle). In particular, a process may homogeneously blend 50% Post Consumer Recycle (PCR) material with 50% Post Commercial/Post Industrial material.

As used herein, Post Consumer Recycle (PCR) material is defined as single-use consumer products comprising film, packaging, and flexibles, which when taken together, comprise at least 75% of any combination of one or more of: Polyethylene Terephthalate (PET) (group 1); Polyvinyl Chloride (PVC or Vinyl) (group 3); Polystyrene (PS or Styrofoam) (group 6); and other unidentified plastic (group 7).

As used herein, Post Commercial/Post Industrial material is defined as multi-use or recycled products, which when taken together, comprise at least 75% of any combination of one or more of: High Density Polyethylene (HDPE), Polyethylene (PE), and Polyphenylene Ether (PPE) (group 2); Polypropylene (PP) (group 4); and Polystyrene (PS or Styrofoam) (group 5).

As used herein, recycled products combine materials of residential, commercial, and industrial streams for mechanical and physical conversion for circular introduction to end-use products beyond single-use mass balance accounting.

Aspects provide different ratio of material between Post Consumer Recycle (PCR) material and Post Commercial/Post Industrial material. In particular, processes may homogeneously blend Post Consumer Recycle (PCR) material and Post Commercial/Post Industrial material in the following proportions, wherein remaining proportions may be virgin material.

| Post Consumer Recycle (PCR) | Post Commercial/Post Industrial |
|---|---|
| at least 10% | at least 10% |
| at least 20% | at least 20% |
| at least 30% | at least 30% |
| at least 40% | at least 40% |
| at least 50% | at least 50% |

Processes may homogeneously blend Post Consumer Recycle (PCR) material and Post Commercial/Post Industrial material in any proportion between the range where Post Consumer Recycle (PCR) material is 10% and Post Commercial/Post Industrial is 90% on the one end of the range and Post Consumer Recycle (PCR) material is 90% and Post Commercial/Post Industrial material is 10% on the other end of the range.

Through processes of reduction, such as shredding, granulation, pulverization and reticulation, the feedstock materials can be reduced to micron-sized chips and flakes to then be used as input material for industrial applications or end-use products. Specifically, a 50/50 homogeneous blend of micron-sized chips and flakes may be formed into pellets configured to be feedstock, which can then be seamlessly added to currently available manufacturing equipment and processes to make molded plastic products, such currently available manufacturing equipment and processes include: stamp or press, injection, compression, drop, roto, and extrusion molding, without limitation. The pellets may be added to virgin plastic feedstock or they may be processed by themselves in various currently available manufacturing equipment and processes.

According to aspects, there is provided a processing application that consists of sorting, removal of tramp metal, removal of aluminum, re-sizing material, pelletizing, cooling, and bagging of pellets. The recycled plastics both from industrial recycled plastic packaging and post-consumer recycling may be processed. Application may provide the ability to configure an engineered recycled plastic pellet that may be used to manufacture recycled plastic products. Specifically, a nesting pallet, having sufficient strength and rigidity to allow fork-lift transportation of heavy objects, may be manufactured from recycled plastic pellets by currently available stamp molding manufacturing equipment and processes. Additionally, a rackable pallet, having sufficient strength and rigidity to allow fork-lift transportation and rack storage of heavy objects, may be manufactured from recycled plastic pellets by currently available injection molding manufacturing equipment and processes.

Higher polyethylene or PE plastics may be easier to recycle, as they can be reduced to micron-sized chips and flakes to then be used as commercial or industrial feedstocks, and finally processed with resins or polymer compounds into an end-use product to market. Post Consumer Recycle materials may be more difficult to recycle because plastics like film, labels, wrap, packaging, and thermoset, without limitation, may go through additional processing to reduce these materials into a recyclable feedstock that can meet quality, efficiency, and the scalability criteria to be utilized in currently available manufacturing equipment and processes.

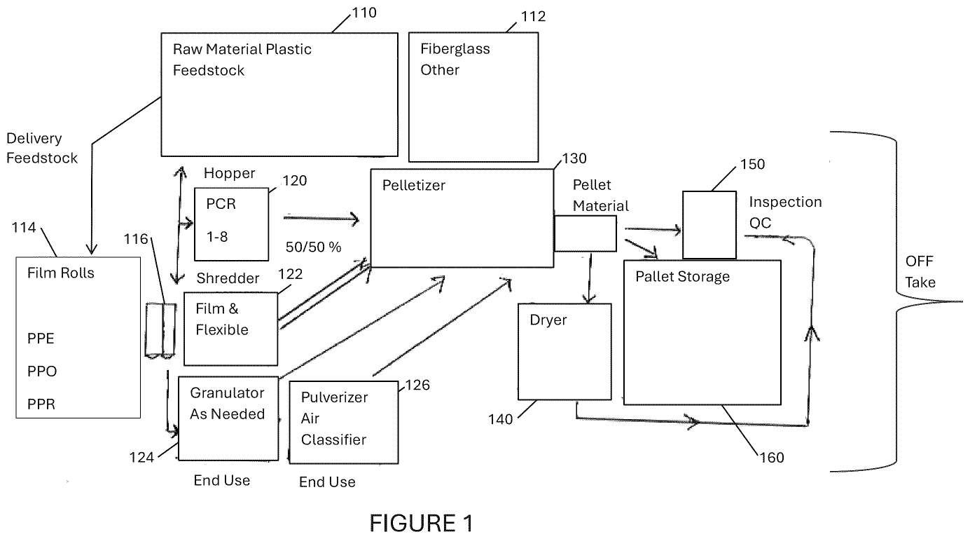

FIG. 1 shows a block diagram of a recycled plastic pellet forming system. Feedstocks of a variety of plastic materials are loaded into a sorting device 116. A raw material plastic feedstock 110 feeds material into sorting device 116. A fiberglass feedstock 112 feeds into sorting device 116. A film roll feedstock 114 feeds material into sorting device 116, wherein the film rolls may comprise PPE, PPO, or PPR, without limitation. Additional delivery feedstocks may also feed material into sorting device 116. The sorting device 116 may include both hand sorting and/or mechanical sorting. The sorting device 116 delivers material to any one of a hopper 120, a shredder 122, a granulator 124, or a pulverizer 126. The hopper 120 may receive any one or more of the “one through seven” most common types of plastic, including PCR. The shredder 122 may receive film and flexible plastic materials. The granulator 124 may receive end use plastic materials. The pulverizer 126 may be an air classifier and may receive end use plastic materials. Plastic materials from the hopper 120, the shredder 122, granulator 124, and pulverizer 126 may be feed into a pelletizer 130. The pelletizer 130 may comprise a wash tank, a dryer, a heater to soften or melt the plastic micronized pieces, an extruder to induce heat and pressure on the plastic pulp and output plastic rods from extruder orifices, a cooling tank to cool and harden the plastic rods, and a cutter to cut the plastic rods into pellets. The pellets may then pass to a dryer 140, an inspection quality control station 150, or to pellet storage 160.

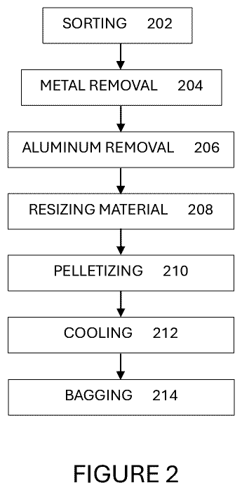

FIG. 2 shows a flow chart of a process that homogeneously blends 50% of single-use plastics and Post Consumer hard to recycle materials with 50% PE and/or PPE film, label and wrap (also difficult to recycle) into pellets suitable for use in various currently available manufacturing equipment and processes to make end products from the recycled material. Single-use plastics and Post Consumer materials are sorted 202 to remove foreign materials. Magnet systems remove 204 tramp metal from the single-use plastics and Post Consumer materials. Eddy current systems remove 206 aluminum from the single-use plastics and Post Consumer materials. The single-use plastics and Post Consumer materials are then resized 208 via a shredder, granulator, and/or a pulverizer. The recycled materials are then pelletized 210 by pressing the material into dense pellets. The pellets are cooled 212 to ambient temperature. The cooled pellets are bagged 214 at room temperature so they may be stored in a dry location.

Aspects provide a process that homogeneously blends 50% of single-use plastics and Post Consumer hard to recycle materials with 50% PE and/or PPE film, label and wrap (also difficult to recycle) into pellets suitable for use in various currently available manufacturing equipment and processes to make end products from the recycled material. The process may include aspects as follows.

Sorting: Sorting includes both hand removal of foreign materials and breaking open of post-consumer waste bags to visually inspect for foreign materials. This process can be accomplished via hand sorting and/or mechanical sorting. Materials may be preconcentrated to remove pollutants, such as wood, rubber, and metals. The materials may be washed and further sorted to separate polyolefins and styrencis. Contaminants such as metals, non-plastics, and foreign objects may be separated to create polymer concentrates. Separation of contaminants from plastics and unwanted colours may enable PET bottles or mixed plastics to be freed of all foreign substances (including black and solid-coloured plastic parts), and sorted by colour categories before passing on to further processing.

Removal of Tramp Metal: Tramp metal is detrimental to the extrusion process downstream. Magnetic contaminants (e.g. wire, screws, nails, without limitation) may be separated from the material stream of pre-sorted plastics by a self-cleaning overhead suspended magnet. The recycle material travels on a conveyer belt under a magnet where metals are removed by the magnet. Non-ferrous and heavy metals in the product stream and their commingled waste may be separated by an eddy current separator.

Removal of Aluminum: Aluminum is unable to be removed via standard magnet systems so an eddy current system may remove aluminum from the recycled materials. Eddy current separators may remove non-ferrous materials such as aluminum and copper from non-metallic material. Non-ferrous materials pass over a shell containing rotating magnets creating eddy currents. A magnetic field is created around the metals repelling them away from the magnet. This repulsion of the non-ferrous materials separates them from the non-metallic materials.

Re-sizing materials: The recycled materials may be sized down for the pellet mill to receive. In particular, plastic materials can be reduced to micron-sized chips and flakes having particles sizes between 1-5 microns, 1-20 microns, or 1-50 microns. Smaller particles between 0.001 and 1 micron may also be included. Chips and flakes may comprise a variety of regular and irregular shapes and sizes including sphere, colloid, planar, without limitation. One way to define particle size is by filtering particles through a screen. Mesh size refers to the mesh number (a US measurement standard) and its relationship to the size of the openings in the mesh and thus the size of particles that can pass through these openings. Recycled materials may be sized down and passed through a screen having a mesh size of 270. This sizing down is accomplished via a shredder unit and sometimes when necessary a granulator. A shredder may be used in connection with a granulator to reduce plastic scrap from bulky or oddly-shaped pieces into a consistent particle size. A plastic granulator may contain a cutting chamber with rotating blades passing close to stationary blades that cut the plastic into smaller pieces. Particle size reduction is the mircronization and milling process to generate a more consistent particle size distribution. Micronized chips and flakes may further be dried to reduce moisture content to less than 3%, in particular, less than 2%.

Homogeneous Mixing: Micronized chips and flakes may be homogeneously blended to contain: (1) Post Consumer Recycle (PCR) material; and (2) Post Commercial/Post Industrial material. Processes may homogeneously blend Post Consumer Recycle (PCR) material and Post Commercial/Post Industrial material in any proportion between the range where Post Consumer Recycle (PCR) material is 10% and Post Commercial/Post Industrial is 90% on the one end of the range and Post Consumer Recycle (PCR) material is 90% and Post Commercial/Post Industrial material is 10% on the other end of the range. Micronized chips and flakes may be made into a homogeneous blend.

According to aspects, micronized chips and flakes may be homogeneously blended by combining streams of (1) Post Consumer Recycle (PCR) material, and (2) Post Commercial/Post Industrial material and mechanically blending or mixing via a ribbon blender, drum tumbler, paddle blender, auger hopper, whisk, vertical cone screw, twin-paddle mixer, without limitation. In one example, the material streams are dry (comprising less than 5% moisture, in particular less than 3% moisture), and the homogeneous blend is dried to comprise less than 3% moisture, in particular less than 2% moisture, prior to pelletizing. Air may be injected into the micronized chips and flakes before and/or during combining of streams and/or blending or mixing. Micronized chips and flakes may be “fluidized” when the particles are surrounded by air, or any other gas, so that the particles touch each other less and friction between particles is reduced, which may facilitate blending or mixing. Micronized chips and flakes may be moved by air conveyance, which uses air or another gas to move streams or homogeneous blend through an enclosed pipeline.

Pelletizing: The recycled materials of a homogeneous blend may then be pelletized (pressed into dense pellets). This process may follow a strict awareness of temperature and material flow. If the pellets are heated above 125° F. then the plastic may gum-up and plug the pellet mill die. A combination of temperature and pressure may be applied depending on the proportions of material streams contributing to the homogeneous blend. The plastic material is fed into a feed hopper to direct the material into a screw chamber. The screw chamber is heated to about 110° F. to about 140° F. so that different plastic materials soften, become tacky, or melt. A screw in the chamber compresses the plastic material until it extrudes through a mill die having one or more extrusion orifices at an end of the screw chamber. As the plastic material extrudes through the mill die, one or more plastic ropes are formed. The ropes may be cooled to allow the plastic to solidify and then cut into pellets, or the ropes may be immediately cut into pellets as the ropes exit the mill die.

Cooling: After pelletizing the pellets are warm and need to be brought down to ambient temperature prior to bagging. This keeps the pellets from clumping together and any moisture in the material has time to vent out. This is achieved with a pellet cooling system. Pellets may further be dried to reduce moisture content to less than 3%, in particular, less than 2%.

Bagging: As important as any step is the packaging of the pellets. The pellets need to be bagged at room temperature and need to be stored in a dry location. Water is detrimental to the extrusion process downstream.

Although examples have been described above, other variations and examples may be made from this disclosure without departing from the spirit and scope of these disclosed examples.

1. A method comprising:
resizing Post Consumer Recycle (PCR) material to 270 mesh particles;
resizing Post Commercial/Post Industrial material to 270 mesh particles;
mixing the resized Post Consumer Recycle (PCR) material and the resized Post Commercial/Post Industrial material into a homogeneous blend, wherein the blend comprises at least 10% Post Consumer Recycle (PCR) material and at least 10% Post Commercial/Post Industrial material;
heating the homogeneous blend to a temperature greater than 110° F.;
extruding the homogeneous blend through an orifice between 2.0 mm and 15.0 mm in diameter to form a rope; and
cutting the rope into pellets between 2.0 mm and 25.0 mm in length.

2. The method of claim 1 comprising:
resizing Post Consumer Recycle (PCR) material to 325 mesh particles; and
resizing Post Commercial/Post Industrial material to 325 mesh particles.

3. The method of claim 1 comprising:
resizing Post Consumer Recycle (PCR) material to 400 mesh particles; and
resizing Post Commercial/Post Industrial material to 400 mesh particles.

4. The method of claim 1 wherein the homogeneous blend comprises at least 20% Post Consumer Recycle (PCR) material and at least 20% Post Commercial/Post Industrial material.

5. The method of claim 1 wherein the homogeneous blend comprises at least 30% Post Consumer Recycle (PCR) material and at least 30% Post Commercial/Post Industrial material.

6. The method of claim 1 wherein the homogeneous blend comprises at least 40% Post Consumer Recycle (PCR) material and at least 40% Post Commercial/Post Industrial material.

7. The method of claim 1 wherein the homogeneous blend comprises at least 50% Post Consumer Recycle (PCR) material and at least 50% Post Commercial/Post Industrial material.

8. The method of claim 1 comprising heating the homogeneous blend to a temperature greater than 130° F.

9. The method of claim 1 comprising heating the homogeneous blend to a temperature greater than 150° F.

10. The method of claim 1 comprising extruding the homogeneous blend through an orifice between 4.0 mm and 6.0 mm in diameter to form a rope.

11. The method of claim 1 comprising cutting the rope into pellets at least 10.0 mm in length.

12. A pellet manufactured by a process comprising:
resizing Post Consumer Recycle (PCR) material to 270 mesh particles;
resizing Post Commercial/Post Industrial material to 270 mesh particles;
mixing the resized Post Consumer Recycle (PCR) material and the resized Post Commercial/Post Industrial material into a homogeneous blend, wherein the blend comprises at least 10% Post Consumer Recycle (PCR) material and at least 10% Post Commercial/Post Industrial material;
heating the homogeneous blend to a temperature greater than 110° F.;
extruding the homogeneous blend through an orifice between 2.0 mm and 15.0 mm in diameter to form a rope; and
cutting the rope into pellets between 2.0 mm and 25.0 mm in length; and
the pellet comprising:
at least 10% Post Consumer Recycle (PCR) material and at least 10% Post Commercial/Post Industrial material; and
having a diameter between 2.0 mm and 15.0 mm and a length of between 2.0 mm and 25.0 mm.

13. A pellet as in claim 12, comprising:
at least 20% Post Consumer Recycle (PCR) material and at least 20% Post Commercial/Post Industrial material.

14. A pellet as in claim 12, comprising:
at least 30% Post Consumer Recycle (PCR) material and at least 30% Post Commercial/Post Industrial material.

15. A pellet as in claim 12, comprising:
at least 40% Post Consumer Recycle (PCR) material and at least 40% Post Commercial/Post Industrial material.

16. A pellet as in claim 12, comprising:
at least 50% Post Consumer Recycle (PCR) material and at least 50% Post Commercial/Post Industrial material.
